(19) United States
(12) Patent Application Publication
(10) Pub. No.: US 2014/0033985 A1
(43) Pub. Date: Feb. 6, 2014

(54) FILING PAD DESIGNED TO ALLOW DOGS TO FILE THEIR OWN CLAWS

(71) Applicant: Joseph Santiago, Miami Beach, FL (US)

(72) Inventor: Joseph Santiago, Miami Beach, FL (US)

(21) Appl. No.: 13/544,991

(22) Filed: Jul. 9, 2012

(51) Int. Cl. A01K 13/00

(52) U.S. Cl. CPC A01K 13/00
USPC 119/621

(57) ABSTRACT

This invention is a nail file for pets! It is made of similar materials used to construct commercial grade emery boards for human use, but with a grit and sturdiness that is designed for a pets thicker and harder claw. The pad is a safe alternative to trim claws over cutting them with dangerous clips that can potentially cut into blood vessels and/or nerves beneath the claw, or the noisy motorized trimmers that are found to cause trauma to animals by frightening them.

To use; just mount onto any gate, door or any flat surface where the pet tends to scratch in the home and simply let them do all the work! The pet will actually file their own claws!

### BACKGROUND

Very excited or nervous pets often scratch and hurt one's skin when innocently vying for attention or playing. As well as ruining expensive flooring, carpets, doors and furniture. Not maintaining a dog's claws could not only lead to the previously described destruction, but could also cause health problems for the animal. Such as ingrown nails, split nails, paw and joint problems. The current home motorized rotary sanders just cause more trauma to the dog by scaring them immensely. And with clippers most pet owners are aware that there are blood vessels and nerves that supply the nail, called the quick, that are inside of each dog claw that could easily cause injury if cut. Because of this danger or the simple fact that trimming these claws at home is just too troublesome, owners resort paying to have this done professionally. Even when paying to have it done, the groomer may resort to sedating the animal to complete the job.

### BRIEF SUMMERY

To alleviate all the problems associated with trimming dog nails both in home and professionally, this invention allows the pet to simply trim their own claws by simply installing the invention anywhere the dog scratches repeatedly. It can be easily hung on a pet gate or even attached to a door or wall and removed when needed. The additional advantage is that there is no need for a pet owner to have to do anything after the easy installation, other than periodically removing the device as needed.

### BRIEF DESCRIPTION OF THE DRAWINGS

The invention can be better understood when consideration is given to the following detailed description thereof.

FIG. 1 Is a front view of the invention.

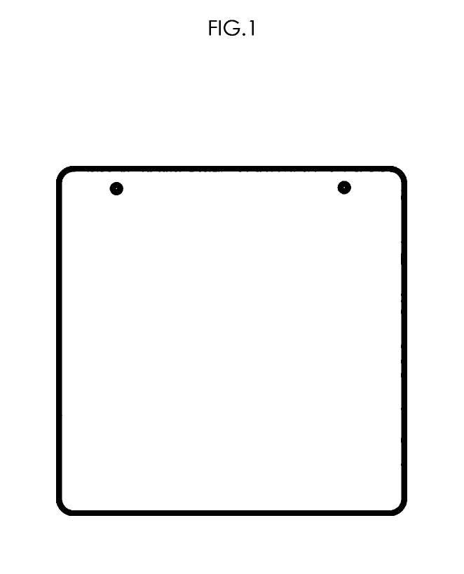

FIG. 2 Is a perspective view showing the constructed finished invention.

FIG. 3 Shows a perspective view of a sample installation of the pad hung on a pet gate.

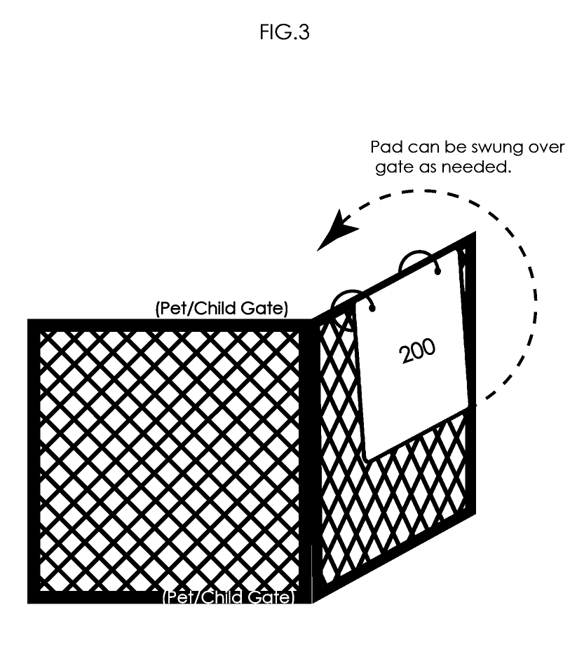

FIG. 4 Showing typical locations to apply Velcro® to mount to a flat surface such as wall or door.

### DETAILED DESCRIPTION

As previously discussed, this present invention allows for a dog to actually do all the work necessary to file their own claws without any effort by it's owner or added stress to the dog. By simply installing the filing pad anywhere the dog scratches on a regular basis. Whether that is a gate the dog is kept in, or on the door or floor it scratches routinely.

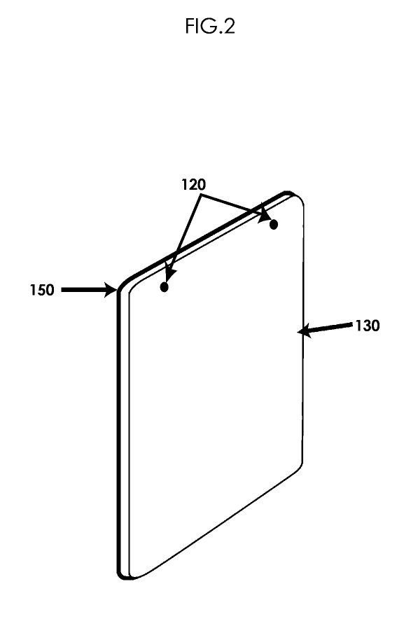

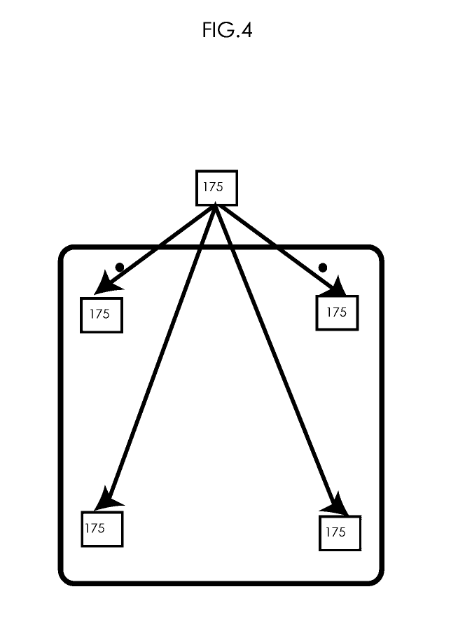

The filing pad within this particular embodiment preferably comprises of a sub-board sheet of flexible plastic, sponge-board, (wood or similar materials may also be used) 150. Then abrasive material, grit (including but not limited to sandpaper) 130 is directly bonded to the sub-board using spray adhesives, adhesives or glue. It is then perforated by mounting holes 120 so as to mount the entire device using any common straps or rope (FIG. 2) Or by simply placing one side of Velcro® 175 to the device (FIG. 4) and the other side to the desired flat surface. This will allow the removal of the filing pad when or if needed.

I claim:

1-The filing pad comprising of an abrasive front side is used for the purpose of safely filing a dog claw.

2-It can be conveniently placed and removed from any gate or clean flat surface.
